(19) United States
(12) Patent Application Publication
(10) Pub. No.: US 2011/0313859 A1
(43) Pub. Date: Dec. 22, 2011

(54) TECHNIQUES FOR ADVERTISER GEOTARGETING USING MAP COORDINATES

(75) Inventors: William Stillwell, King County, WA (US); Darrell Blegen, Redmond, WA (US); Melissa Dunn, Woodinville, WA (US); Daniel Schiappa, Redmond, WA (US); Martin O'Keefe, Redmond, WA (US); Arthur Chen, Fall City, WA (US); Benjamin-Joseph Woodall, Seattle, WA (US); John Carey, Sammamish, WA (US); Alexander Gounares, Kirkland, WA (US); Shankar Vaidyanathan, Sammamish, WA (US); Jen-Hsien Chien, Bellevue, WA (US); Marek Dawiec, Redmond, WA (US)

(73) Assignee: MICROSOFT CORPORATION, Redmond, WA (US)

(21) Appl. No.: 12/821,004

(22) Filed: Jun. 22, 2010

(51) Int. Cl. G06Q 30/00

(52) U.S. Cl. 705/14.58

(57) ABSTRACT

Techniques to provide geo-targeted advertising are described. A technique may include displaying a map to an advertiser at a first zoom level. The advertiser may stay at the first zoom level or change to a second zoom level. The advertiser may also create a user-defined area of the map. The advertiser may select an advertising campaign, and the advertising system may associate the selected advertising campaign with the user-defined area and the selected zoom level. The advertising system may then provide the selected advertising campaign for display in a mapping application operating on a client device when the user-defined area and the selected zoom level are viewed in the mapping application. Other embodiments are described and claimed.

### BACKGROUND

Mapping applications may allow advertisers to display an advertisement near the map display. Mapping applications may provide a way for an advertiser to target an advertisement to a particular map area. Conventional targeting methods may include, for example, setting a circular target area around a central longitude and latitude, specifying a zip code, specifying a metropolitan area or other objective boundaries, such as county lines. It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to techniques for advertiser geotargeting. Some embodiments are particularly directed to techniques for advertiser geotargeting that allow an advertiser to select irregular boundaries for a target area, or to select a specific zoom level at which the advertisement will appear. In one embodiment, for example, a technique may include displaying a map to an advertiser at a first zoom level. The advertiser may stay at the first zoom level or change to a second zoom level. The advertiser may also create a user-defined area of the map. The advertiser may select an advertising campaign, and the advertising system may associate the selected advertising campaign with the user-defined area and the selected zoom level. The advertising system may then provide the selected advertising campaign for display in a mapping application operating on a client device when the user-defined area and the selected zoom level are viewed in the mapping application. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a geo-targeted advertising system.

FIG. 2 illustrates an embodiment of an ad campaign creation system.

FIG. 3 illustrates an embodiment of a mapping user interface.

FIG. 4 illustrates two embodiments of a device and interface.

FIG. 5 illustrates an embodiment of a logic flow for creating a geo-targeted ad campaign.

FIG. 6 illustrates an embodiment of a logic flow for selecting a geo-targeted ad for display.

FIG. 7 illustrates an embodiment of a computing architecture.

FIG. 8 illustrates an embodiment of a communications architecture.

### DETAILED DESCRIPTION

Various embodiments are directed to an advertising method and system that allows an advertiser to customize an advertisement target area and to control when the advertisement will appear to a map viewer based on a zoom level on the map. Embodiments may provide a user interface to allow the advertiser to draw the outline of the target area. The drawn outline may then be used to identify map elements that correspond to the outlined area. The map elements may then be associated with the advertiser's advertisement campaign. When a user of the map application views the target area at a specified zoom level, the ad campaign may be displayed to the user.

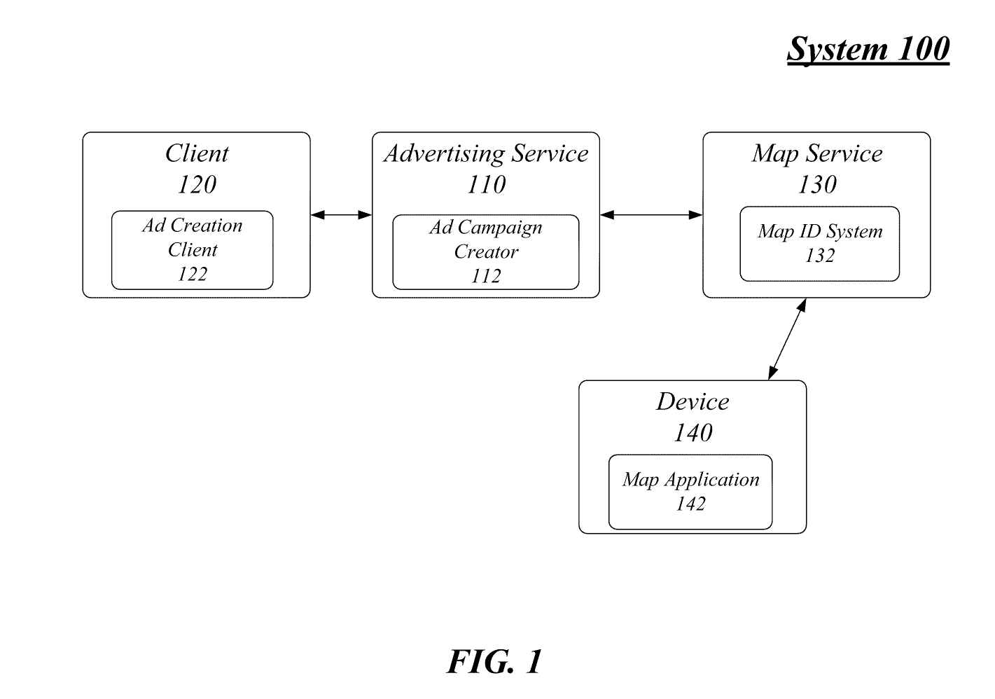

FIG. 1 illustrates a block diagram for a system 100 for advertisement geotargeting. In one embodiment, for example, the system 100 may comprise a computer-implemented system 100 having multiple components, such as advertising service 110, a client 120, a map service 130, and a device 140. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented as part of one or more electronic devices. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The components 110, 120, 130, 140 may be communicatively coupled via various types of communications media. The components 110, 120, 130, 140 may coordinate operations between each other. The coordination may involve the uni-directional or bi-directional exchange of information. For instance, the components 110, 120, 130, 140 may communicate information in the form of signals communicated over the communications media. The information can be implemented as signals allocated to various signal lines. In such allocations, each message is a signal. Further embodiments, however, may alternatively employ data messages. Such data messages may be sent across various connections. Examples of connections include parallel interfaces, serial interfaces, and bus interfaces.

In various embodiments, the system 100 may comprise advertising service 110. Advertising service 100 may create and/or store advertisements for display in various venues. Advertising service 100 may comprise an ad campaign creator 112 that may allow potential advertisers to create a targeted ad campaign and specify where the ad campaign should be displayed.

In various embodiments, the system 100 may comprise client 120. Client 120 may be a computing device operated by an advertiser. Client 120 may be in communication with advertising service 110 to create a targeted advertising campaign. In an embodiment, client 120 may comprise an ad creation client 122. Ad creation client 122 may be an application operative on client 120, or may be an interface to ad campaign creator 112. Ad creation client 122 may display a map and allow the advertiser to “draw” an area, that when displayed in a mapping application, may cause the ad campaign to be displayed with the map area.

In various embodiments, the system 100 may comprise map service 130. Map service 130 may provide map functions, such as displaying road or aerial maps at different zoom levels, providing driving directions between locations, identifying points of interest or businesses in an area, etc.

Map service 130 may include a map identification (ID) system 132. Map ID system 132 may represent areas of a map in such a way as to be able to uniquely identify each point on the map. In an embodiment, a map area may be represented by bounding latitude and longitude. In an embodiment, a map may be represented as a grid, where each grid element may be further divided into equal sub-grids. Each sub-grid may be identified as being a unique component of its parent grid, recursively, and may itself be further subdivided.

Map service 130 may be a component of advertising service 110, or may be operated independently from advertising service 110. In an embodiment, advertising service 110 may operate in coordination with map service 130 to provide advertisements for display with a map.

In various embodiments, the system 100 may comprise a device 140. Device 140 may be a computer, cellular telephone, or mobile device that is capable of displaying and interacting with a map. Device 140 may access map service 130 via a map application 142, which may be an application operating on device 140, or may be accessed via an interface such as a web browser.

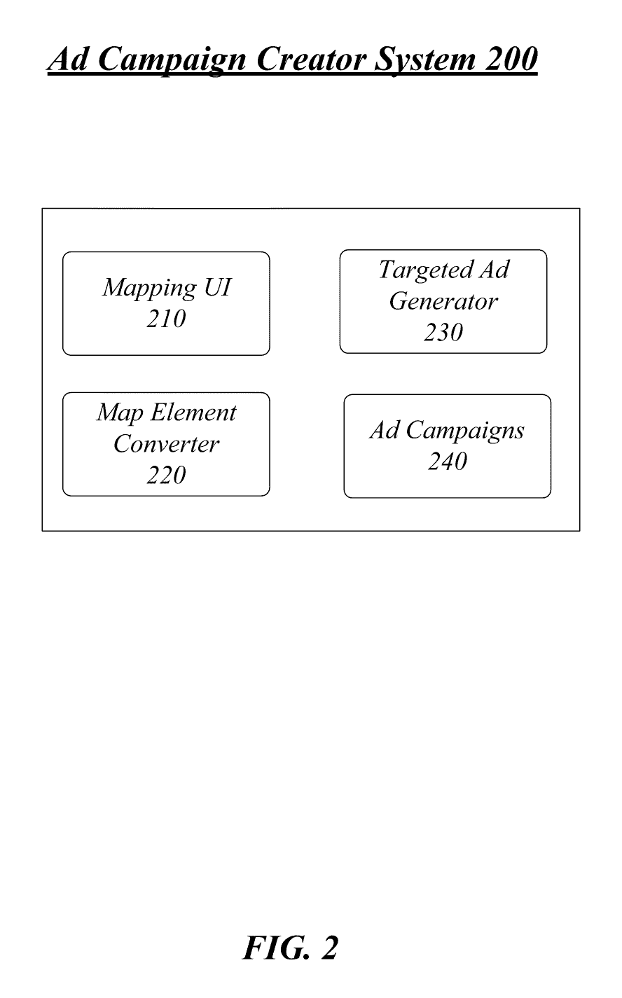

FIG. 2 illustrates a block diagram of an ad campaign creator system 200 for creating a targeted ad campaign. Ad campaign creator system 200 (“system 200”) may be an embodiment of ad campaign creator 112. System 200 may operate on one or more computing devices at advertising system 110, or may operate in part on client 120.

In various embodiments, the system 200 may comprise a mapping user interface (UI) 210. Mapping UI 210 may display a map and may allow the advertiser to scroll in any direction to locate an area in which an ad campaign is to be targeted. Mapping UI may further allow zooming in and out to change the total amount of geographic area being displayed. For example, the advertiser may be able to zoom out to view a whole city or county, or may zoom in to view a neighborhood, or just a few city blocks.

Mapping UI 210 may also provide a drawing tool that allows the advertiser to “draw” an area on the map within which an ad campaign will be targeted. The advertiser may be able to use a mouse, a stylus, a fingertip, or other input device to draw the target area on the map.

In various embodiments, the system 200 may comprise a map element converter 220. Map element converter 220 may determine what map elements are contained within the drawn target area. In an embodiment, map element converter 220 may identify different sizes of map elements needed to include the target area. Map element converter 220 may retrieve the map identifiers used by the map ID system 132 of map service 130. If advertising service 110 uses a different system for map element identification, then map element converter 220 may convert that map identifiers to the advertising system 110 identifiers.

In various embodiments, the system 200 may comprise a targeted ad generator 230. Targeted ad generator 230 may associate the map identifiers from map element converter 220 with one or more ad campaigns. Target ad generator 230 may provide an interface that allows the advertiser to create and/or select an ad campaign to associate with a target area. Targeted ad generator 230 may also provide other targeting attributes in addition to the target area, such as demographic attributes.

In various embodiments, the system 200 may comprise ad campaigns 240. Ad campaigns 240 may be stored advertisements that may be associated with a target area and later retrieved and provided for display in conjunction with a map area being viewed. Ad campaigns 240 may be images, videos, sounds, hyperlinks, or combinations thereof.

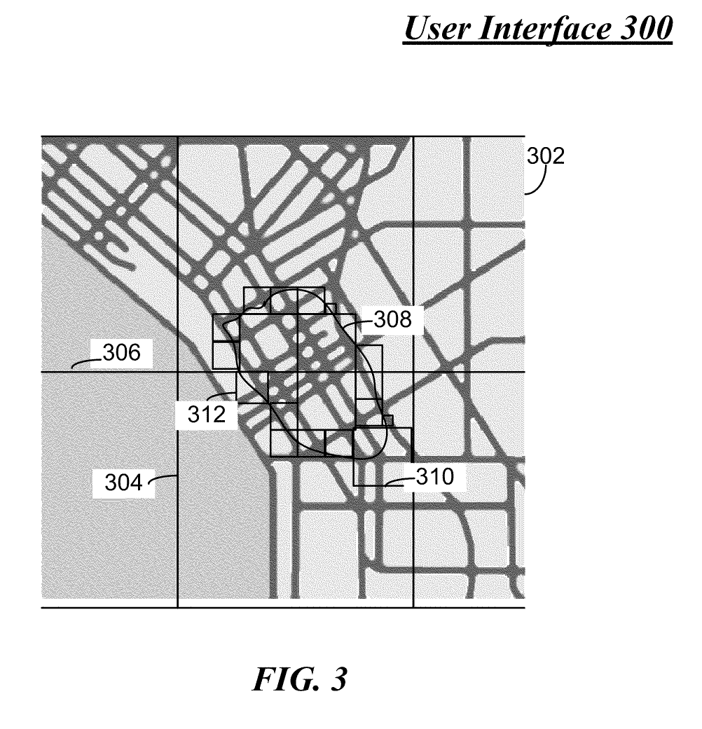

FIG. 3 illustrates an example of a user interface 300. UI 300 may be an embodiment of mapping UI 210. UI 300 shows a map 302 of a street view of a city. For the purposes of illustration, FIG. 3. shows a set of grid lines, e.g. lines 304 and 306, that correspond to map ID system 132. UI 300 may show or hide such grid lines. In FIG. 3, an advertiser has drawn a target area denoted by line 308. In this example, line 308 is irregular and non-circular. Map element converter 220 has identified the map elements that correspond to the target area. In an embodiment where map ID system 132 uses the grid and sub-grid system described above, the map elements in the target area may be represented by a number of sub-grids of varying sizes, for example, sub-grid 310 and sub-grid 312. In an embodiment, map element converter 220 may retrieve the identifiers of the map elements and group the identifiers as the target area.

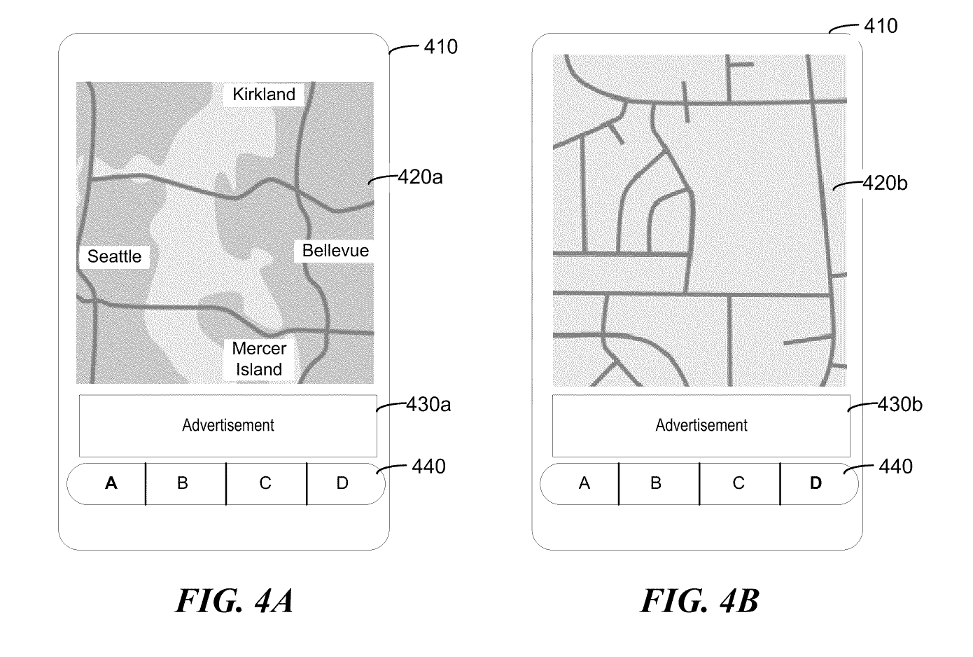

FIGS. 4A and 4B illustrate two views on a device 410. Device 410 may be an embodiment of device 140. Device 410 may be using map application 142.

A map is displayed in display area 420a, 420b. Display area 420a shows a map at a low zoom level, e.g., a county level view that shows several cities. Display area 420b shows a higher zoom level, such as a street level view that shows only a few blocks.

Device 410 may show an advertisement in ad block 430a, 430b. In an embodiment, the ad in ad block 430a may be different from the ad shown in ad block 430b. The ad in ad block 430a may have been selected because the map shown in display area 420a is showing a particular set of map elements, at a particular zoom level. Similarly, the ad shown in ad block 430b may have been selected because the map shown in display area 420b is showing a particular set of map elements, at a particular zoom level.

Device 410 may show a zoom bar 440. Zoom bar 440 may illustrate what level of zoom is being displayed. In FIG. 4A, the “A” level may correspond to a county level, or a percent of zoom. In FIG. 4B, the “D” level may correspond to street level, or full zoom. Zoom bar 440 may contain more or fewer gradients of zoom, and may allow the user of device 410 to switch zoom levels be selecting the different levels. Other methods of zooming in and out are also possible. The embodiments are not limited to this example.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

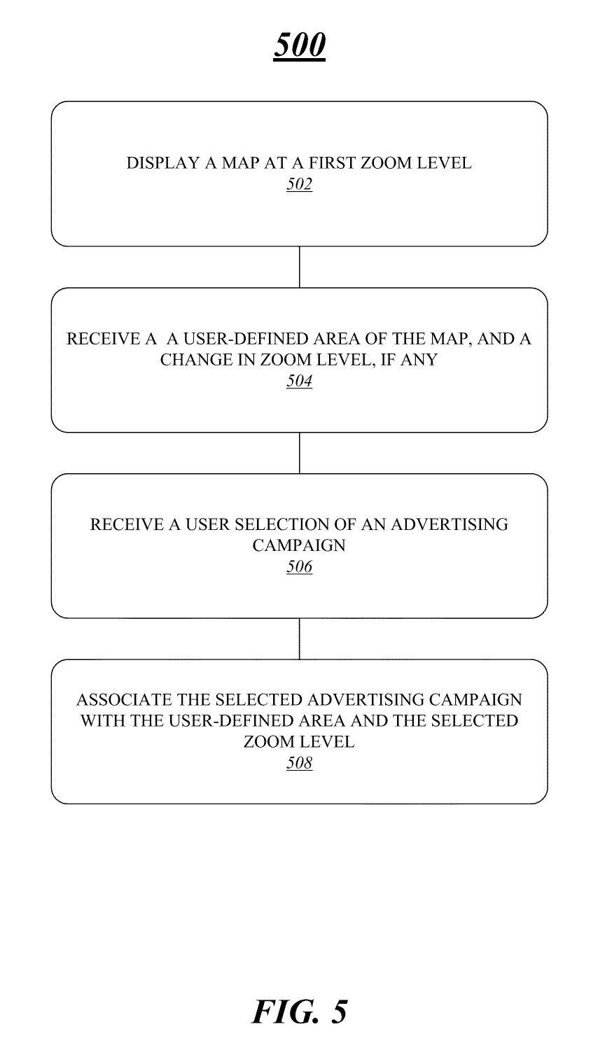

FIG. 5 illustrates one embodiment of a logic flow 500. The logic flow 500 may be representative of some or all of the operations executed by one or more embodiments described herein. In particular, the logic flow 500 may represent the operations of ad campaign creator 112.

In the illustrated embodiment shown in FIG. 5, the logic flow 500 displays a map at a first zoom level at block 502. For example, ad campaign creator 112 may, via mapping UI 210, display a map of the advertiser's current location, or a default location, or a specific address entered previously by the advertiser.

The logic flow 500 may receive a user-defined area of the map, and a change in zoom level, if any, at block 504. For example, the advertiser may change the zoom level to a desired level, and draw the target area for an ad campaign using ad creation client 122 and/or mapping UI 210. The user-defined are of the map may be converted to map elements and/or map identifiers.

The logic flow 500 may receive a selection of an advertising campaign at block 506. For example, the advertiser may create an ad campaign with target ad generator 230, upload an ad campaign, or select from stored ad campaigns 240.

The logic flow 500 may associate the selected ad campaign with the user defined area and the selected zoom level at block 508. For example, targeted ad generator 230 may store a targeted ad campaign as a set of map identifiers, a zoom level and an ad campaign identifier. In an embodiment, more than one target area may be associated with an ad campaign.

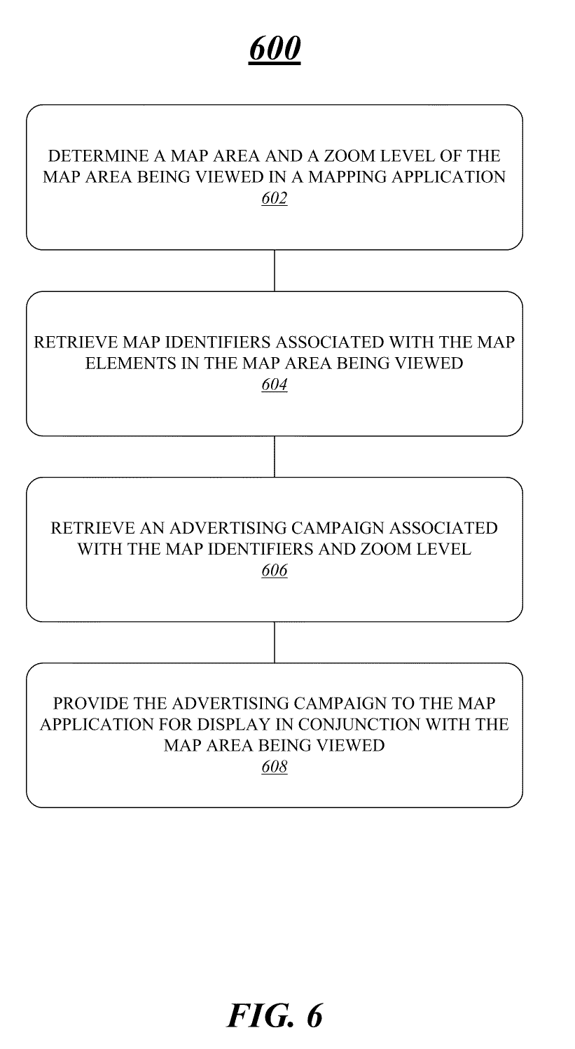

FIG. 6 illustrates one embodiment of a logic flow 600. The logic flow 600 may be representative of some or all of the operations executed by one or more embodiments described herein.

In the illustrated embodiment shown in FIG. 6, the logic flow 600 may determine which map area is being viewed, and the zoom level of the view, at block 602. For example, map service 130 may determine the map elements needed for display to map application 142. The zoom level may determine which map elements are needed.

The logic flow 600 may retrieve the map identifiers associated with the map elements being viewed, at block 604. For example, if map ID system 132 divides a map into grids and sub-grids, where each grid or sub-grid has a unique ID, then the unique IDs of the largest grids being viewed may be retrieved.

The logic flow 600 may retrieve an advertising campaign at block 606. For example, target ad generator 230 may search stored ad campaigns 240 for those associated with the map identifiers of map elements in the area being viewed. Target ad generator 230 may further check the zoom level being used, and refine the search for those ad campaigns where the same zoom level is associated. If more than one ad campaign meets the criteria, then one may be selected according to an agreement with the advertisers and advertising service 110.

The logic flow 600 may provide the selected ad campaign to the map application for display at block 608. For example, advertising service 110 may transmit an image, video, sound, hyperlink or other ad content to device 140 for display in map application 142. In an embodiment, map service 130 may retrieve the ad content from advertising service 110 and may then transmit the ad content to device 140.

When the user of device 140 and map application 142 changes the map area being viewed, or zooms in or out, the logic flow 600 may be repeated to update the advertising campaign displayed.

In an embodiment, criteria other than, or in addition to, zoom level may be associated with an ad campaign. Such criteria may include, for example, the orientation of the map, the type of map viewed (satellite, road, satellite/road hybrid), whether the map is being viewed as two-dimensional or three-dimensional, etc.

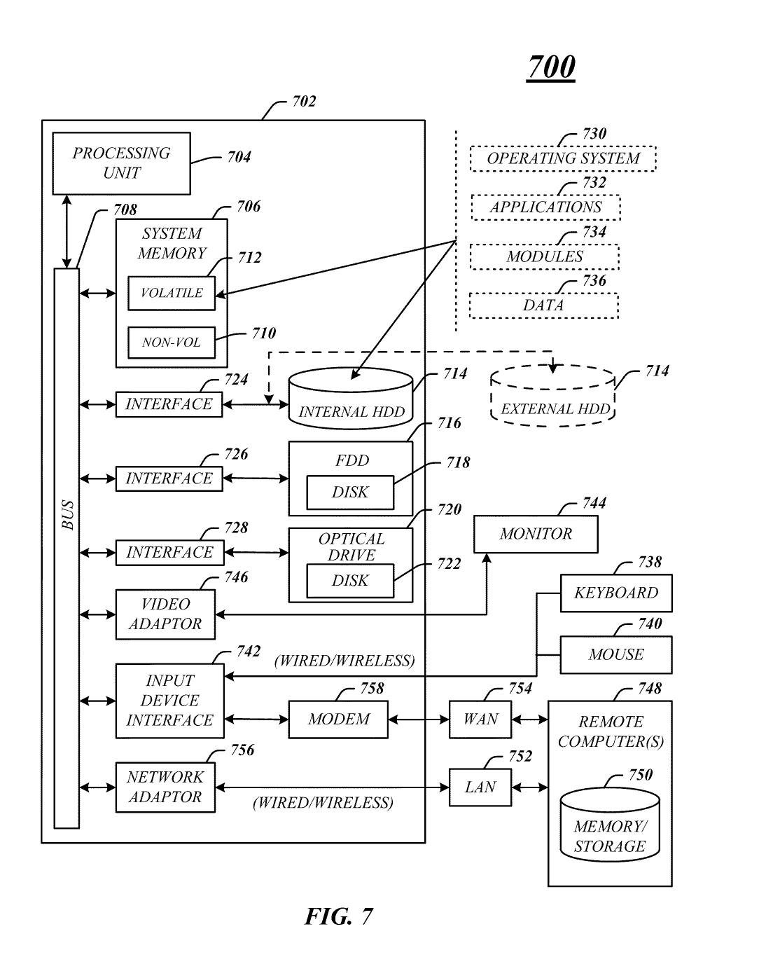

FIG. 7 illustrates an embodiment of an exemplary computing architecture 700 suitable for implementing various embodiments as previously described. The computing architecture 700 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors. Dual microprocessors and other multi-processor architectures may also be employed as the processing unit 704. The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures.

The system memory 706 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media, including an internal hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. The one or more application programs 732, other program modules 734, and program data 736 can include, for example, ad campaign creator 112, map service 130, and map application 142.

A user can enter commands and information into the computer 702 through one or more wire/wireless input devices, for example, a keyboard 738 and a pointing device, such as a mouse 740. Other input devices may include a microphone, an infra-red (IR) remote control, a joystick, a game pad, a stylus pen, touch screen, or the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

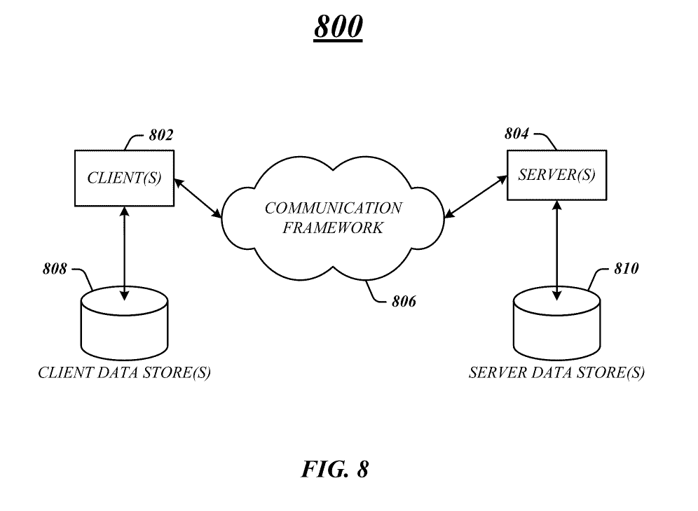

FIG. 8 illustrates a block diagram of an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, and so forth. The embodiments, however, are not limited to implementation by the communications architecture 800.

As shown in FIG. 8, the communications architecture 800 comprises includes one or more clients 802 and servers 804. The clients 802 may implement the client systems 310, 400. The servers 804 may implement the server system 330. The clients 802 and the servers 804 are operatively connected to one or more respective client data stores 808 and server data stores 810 that can be employed to store information local to the respective clients 802 and servers 804, such as cookies and/or associated contextual information.

The clients 802 and the servers 804 may communicate information between each other using a communication framework 806. The communications framework 806 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 802 and the servers 804 may include various types of standard communication elements designed to be interoperable with the communications framework 806, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 802 and a server 804 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
displaying a map at a first zoom level;
receiving a selection of one of the first zoom level or a second zoom level, and a user-defined area of the map;
receiving a user selection of an advertising campaign;
associating the selected advertising campaign with the user-defined area and the selected zoom level; and
providing the selected advertising campaign for display in a mapping application operating on a client device when the user-defined area and the selected zoom level are viewed in the mapping application.

2. The method of claim 1, wherein receiving a user-defined area of the map comprises:
receiving a user-drawn area.

3. The method of claim 1, wherein the user-defined area is non-circular.

4. The method of claim 1, wherein the user-defined area is irregularly shaped.

5. The method of claim 1, wherein the map comprises a plurality of map elements each map element having a unique identifier, and further comprising:
identifying each map element within the user-defined area.

6. The method of claim 5, wherein associating the selected advertising campaign comprises:
converting a map element identifier for a map element in the user-defined area to an advertising system element; and
storing the advertising system element and the advertising campaign for retrieval.

7. The method of claim 1, further comprising:
receiving a plurality of user-drawn areas; and
associating a first advertising campaign with a first user-defined area and a second advertising campaign with a second user-defined area.

8. The method of claim 1, further comprising:
receiving a plurality of user-drawn areas; and
associating the plurality of user-drawn areas with one advertising campaign.

9. The method of claim 1, further comprising:
determining a map area and a zoom level of the map area being viewed in a mapping application;
retrieving map identifiers associated with the map elements in the map area being viewed;
retrieving an advertising campaign associated with the map identifiers and zoom level; and
providing the advertising campaign to the mapping application for display in conjunction with the map area being viewed.

10. An article comprising a storage medium containing instructions that if executed enable a system to:
determine a map area and a zoom level of the map area being viewed in a mapping application, wherein a map comprises a set of map elements;
retrieve map identifiers associated with the map elements in the map area being viewed;
retrieve an advertising campaign associated with the map identifiers and zoom level; and
provide the advertising campaign to the mapping application for display in conjunction with the map area being viewed.

11. The article of claim 10, further comprising instructions that if executed enable the system to:
display a map at a first zoom level;
receive a selection of one of the first zoom level or a second zoom level, and a user-defined area of the map;
receive a user selection of an advertising campaign; and
associate the selected advertising campaign with the user-defined area and the selected zoom level.

12. The article of claim 11, further comprising instructions that if executed enable the system to:
receive a user-drawn area as the user-defined area;
identify each map element in the user-defined area.

13. The article of claim 12, further comprising instructions that if executed enable the system to:
convert a map element in the user-defined area to an advertising system element; and
store the advertising system element and the advertising campaign for retrieval.

14. The article of claim 11, wherein the user-defined area is non-circular.

15. The article of claim 10, further comprising instructions that if executed enable the system to:
retrieve a second advertising campaign when the zoom level of the map area being viewed changes.

16. An apparatus, comprising:
a processor;
a mapping user interface operative on the processor to display a map and receive a user-drawn selection of a map area; and
a targeted ad generator operative on the processor to associate the user-drawn selection of the map area with an advertising campaign, and to provide the associated advertising campaign for display to a mapping application when the user-drawn selection of the map area is displayed in the mapping application.

17. The apparatus of claim 16, further comprising:
a map element converter operative on the processor to convert the user-drawn selection to a set of map elements.

18. The apparatus of claim 17, wherein the set of map elements includes a subset of map elements having a size different from a second subset of map elements.

19. The apparatus of claim 17, wherein each map element has a unique identifier, and the map element converter to convert a map element identifier to an advertising system element; and to store the advertising system element and the advertising campaign for retrieval.

20. The apparatus of claim 16, wherein the user-drawn selection is non-circular.
